(19) United States
(12) Patent Application Publication
(10) Pub. No.: US 2026/0227007 A1
(43) Pub. Date: Aug. 6, 2026

(54) PIPE CLIP

(71) Applicant: J. VAN WALRAVEN HOLDING B.V., MIJDRECHT (NL)

(72) Inventors: Frank NIJDAM, HARDERWIJK (NL); Marek JUZAK, MIJDRECHT (NL)

(21) Appl. No.: 19/128,723

(22) PCT Filed: Nov. 9, 2023
(86) PCT No.: PCT/EP2023/081275

§ 371 Date: May 9, 2025

(30) Foreign Application Priority Data
Nov. 11, 2022 (NL) 2033504

(51) Int. Cl. F16L 3/13; F16L 3/237

(52) U.S. Cl. CPC F16L 3/13; F16L 3/237

(57) ABSTRACT

A pipe clip includes a clip portion and a base portion formed in one piece. The base portion has a support surface to be positioned against a part of a structure, e.g. a floor, a wall, a ceiling. The base portion has a passage extending through the base portion from the support surface to an opposite surface of the base portion for a shaft of a fastener to attach the base portion of the respective pipe clip to the structure. The base portion is adapted to be coupled to a base portion of another pipe clip so as to form a pipe clip assembly. The base portion has a lateral side, which extends from said support surface of the base portion to said opposite surface of the base portion.

### TECHNICAL FIELD

The invention relates to a pipe clip comprising a clip portion and a base portion formed in one piece, the clip portion being adapted to receive and hold a pipe and the base portion adapted to attach the pipe clip to a structure. The base portion has a support surface to be positioned against a part of the structure, e.g. a floor, a wall, a ceiling. The base portion has a passage extending from the support surface to an opposite surface of the base portion for passing through a shaft of a fastener for attaching the base portion of the respective pipe clip to the structure. The base portion is adapted to be coupled to a base portion of another pipe clip so as to form a pipe clip assembly.

### DESCRIPTION OF RELATED ART

In the field of pipe clips there are also known pipe clips that are fixed to a floor by a nail that is preassembled with the base. An example of such a clip is shown in EP 0 648 002 A1. Often this type of clips is used to fix a pipe or tube to a floor surface after which for example concrete floor is poured over the pipes and the pipe clips.

As an alternative of this type of pipe clips to be fixed with a nail, a pipe clip with an integrally formed fastener is known from NL 1001624. This document also shows a dual pipe clip with an integral fastener which extends from the center of the base of the dual clip. The latter pipe clips have the limitation that they can be used only in one orientation due to the integral fastener.

In EP 1 126 571 pipe clips are shown which can be used in different orientations, because the fastener can be mounted to the pipe clip on two ends of the passage. Moreover these pipe clips are modular, in the sense that the pipe clips, either of the single type or the dual type can be mounted on top of each other and coupled with a separate threaded coupling piece.

The foregoing pipe clips require different versions for single and dual pipe clips, which makes manufacturing a range of pipe clips relatively expensive. Moreover, the solution of EP 1 126 571 is relatively complex and consequently expensive. Since in practise this type of clips is often used to fix a pipe or tube to a floor surface after which for example concrete floor is poured over the pipes and the pipe clips there is a need for a simpler solution that can be manufactured at lower costs.

### SUMMARY OF THE INVENTION

Accordingly it is an object of the invention to provide a pipe clip which is versatile in use and which can be produced at relatively low cost.

This object is achieved by a pipe clip according to the preamble of claim 1, wherein the base portion has a lateral side, which extends from said support surface of the base portion to said opposite side of the base portion, which lateral side is adapted to be coupled to a lateral side of the base portion of said other pipe clip to form the said pipe clip assembly, wherein the clip portions of the assembly are located lateral from each other, and wherein the base portion includes a passage half at said lateral side, formed such that when said pipe clips are assembled and coupled to each other, the respective passage halves are positioned opposite each other and together form an additional passage for a shaft of a fastener.

The pipe clip according to the invention can be used as a single pipe clip, in which case a fastener, such as a nail, can be passed through the passage to attach the the base portion to the support such as a floor. The pipe clip according to the invention can also be assembled with another pipe clip of the same type by coupling the base portions of the pipe clips. By coupling the base portions, the assembly does not only have the passages located in the base portions themselves, but also is provided with an additional passage for a fastener, such as a nail, by cooperation of the passage halves formed on the lateral sides of the base portions of the pipe clips to be assembled. In this case the fastener can thus be passed through either one of the passages. Thus, for example, if the base portion has one passage for a fastener extending through it, the assembled pipe clip assembly has three passages for passing through the fastener. This increases the options for fastening. It allows for example to first assemble the pipe clips and then fasten the assembly to a support, such as a floor, through the additional, preferably central, passage resulting from the assembly. However, it is also possible to initially fasten one pipe clip to the support, by a fastener through the existing passage, and afterwards add another pipe clip and assemble it with the already fastened pipe clip. In that case the assembly is fastened to the support via the passage of the base portion of the initially fastened pipe clip.

The pipe clip according to the invention is preferably made of plastic, e.g. by a injection moulding process. The design according to the invention makes it possible that for a certain pipe diameter only one mold is needed to make the pipe clips for single use or for assembled use, e.g. as a dual pipe clip. This reduces the manufacturing costs for these products considerably.

In an embodiment the base portion has at said lateral side at least one coupling member adapted to cooperate with a coupling member of the other pipe clip for assembling said pipe clips so as to create a dual pipe clip. Physical coupling members can be quite easily formed integrally on the base portion in an injection moulding process. The need for separate connecting pieces to connect the pipe clips is avoided.

In a practical embodiment the at least one coupling member may comprise a rib or a channel profile, adapted to cooperate with a channel profile and rib, respectively, of said other pipe clip.

Preferably the rib or channel has a longitudinal direction which extends substantially from the support surface to the opposite surface of the base portion. This makes it possible to attach one pipe clip by means of the fastener to the support, and afterwards couple the other pipe clip by sliding the rib and channel profile, transvers to the support, thus in the example of a floor from above, into each other for coupling the two pipe clips.

Preferably, the rib and channel extend parallel to the passage for the fastener.

In a further embodiment the channel profile comprises a bore having a circular cross section and a longitudinal slot adjoining the bore and forming an opening of the bore along its length, wherein the transition of the slot to the bore constitutes an undercut. The rib is adapted to be inserted in the longitudinal direction in the channel, wherein the rib comprises a thicker rib portion which fits in the bore and a connection portion which fits in the slot and which connects the thicker rib portion to the base portion of the clip. The undercut is such that the thicker rib portion cannot exit from the bore in a direction perpendicular to the longitudinal direction.

In an embodiment the opposite surface of the base portion is also a support surface adapted to be positioned against said part of a structure such as a floor, wall or ceiling, whereby the pipe clip is mountable to said part of the structure in two orientations. This increases the versatility of use of the pipe clip.

In a preferred embodiment the clip body has an open ring shape with an opening to insert the pipe in the ring shape in substantially a radial direction, wherein the opening is facing the same direction as the support surface or said opposite surface of the base portion.

The invention furthermore relates to a pipe clip assembly comprising a first pipe clip and a second pipe clip, each according to the invention.

In the assembled state, the first and second pipe clip of the assembly are coupled to each other and the respective passage halves are positioned opposite each other and together form an additional passage for a shaft of a fastener. This creates a further option to pass the fastener through. The additional passage is preferably located in the centre of the assembled base portions whereby the fastener is symmetrically loaded during use and installation.

In a possible embodiment, wherein the at least one coupling member comprises a rib or a channel profile, adapted to cooperate with a channel profile and rib, respectively, of the other pipe clip of the assembly, the channel profile has a recess at an end of the bore and a snap member is formed on the end of the thicker rib portion, such that when the rib is moved through the bore and passes the end of the bore, the snap member undercuts the edge of the recess, whereby the rib cannot be retracted in the bore.

In a possible embodiment of the pipe clip assembly the first pipe clip and the second pipe clip are identical.

However, in another possible embodiment of the pipe clips assembly the first pipe clip and the second pipe clip are similar. In this embodiment the clip portion of the first clip is suitable for receiving another pipe diameter than the clip portion of the second pipe clip. The base portions however are still adapted to be coupled.

The invention also relates to a pipe clip assembly comprising at least one pipe clip as described in the above and further comprising an auxiliary part adapted to be coupled to the pipe clip, wherein the auxiliary part has a lateral side adapted to be coupled to a lateral side of the base portion of the pipe clip to form the said pipe clip assembly, wherein the auxiliary part includes a passage half at said lateral side thereof, formed such that when said pipe clip and said auxiliary part are assembled and coupled to each other, the respective passage halves are positioned opposite each other and together form an additional passage for a shaft of a fastener. The auxiliary part may be for example be a spacer block that is positioned between two of the described pipe clips for increasing the distance between the central axes of the pipes held by the pipe clips.

### BRIEF DESCRIPTION OF THE DRAWINGS

The invention will be further elucidated in the following description with reference to the drawing, in which:

FIG. 1 shows an isometric view of an embodiment of a pipe clip of a pipe clip assembly according to the invention,

FIG. 2 shows another isometric view of the pipe clip of FIG. 1,

FIG. 3 shows an isometric view of an embodiment of a pipe clip assembly according to the invention in an assembled state,

FIG. 4 shows an isometric view of the pipe clip of FIG. 1 combined with a fastener,

FIG. 5 shows an isometric view of the pipe clip of FIG. 1 in another orientation combined with a fastener,

FIG. 6 shows a detail of the pipe clip assembly of FIG. 3,

FIG. 7 shows a top elevational view of the pipe clip assembly of FIG. 3,

FIG. 8 shows an isometric view of the pipe clip assembly of FIG. 3 combined with a fastener,

FIG. 9 shows an isometric view of the pipe clip assembly of FIG. 3 in another orientation combined with a fastener,

FIG. 10 illustrates in an isometric view the assembly of one pipe clip of FIG. 1, which is post-assembled with an already mounted pipe clip according to FIG. 1,

FIG. 11 shows the pipe clip assembly of FIG. 10 in the assembled state,

FIG. 12 shows the pipe clip of FIG. 4 in the mounted state with a pipe arranged in the pipe clip,

FIG. 13 shows the pipe clip of FIG. 5 in the mounted state with a pipe arranged in the pipe clip,

FIG. 14 shows the pipe clip assembly of FIG. 8 in the mounted state with pipes arranged in the pipe clips of the pipe clip assembly,

FIG. 15 shows the pipe clip assembly of FIG. 9 in the mounted state with pipes arranged in the pipe clips of the pipe clip assembly,

FIG. 16 illustrates in an isometric view the assembly of one pipe clip having a different size, which is post-assembled with an already mounted pipe clip according to FIG. 1,

FIG. 17 shows the pipe clip assembly of FIG. 16 in the mounted state with pipes arranged in the pipe clips of the pipe clip assembly,

FIG. 18 shows an isometric view of an auxiliary part for a pipe clip assembly according to the invention, and

FIG. 19 shows an isometric view of a pipe clip assembly according to the invention including the auxiliary part of FIG. 18.

### DETAILED DESCRIPTION

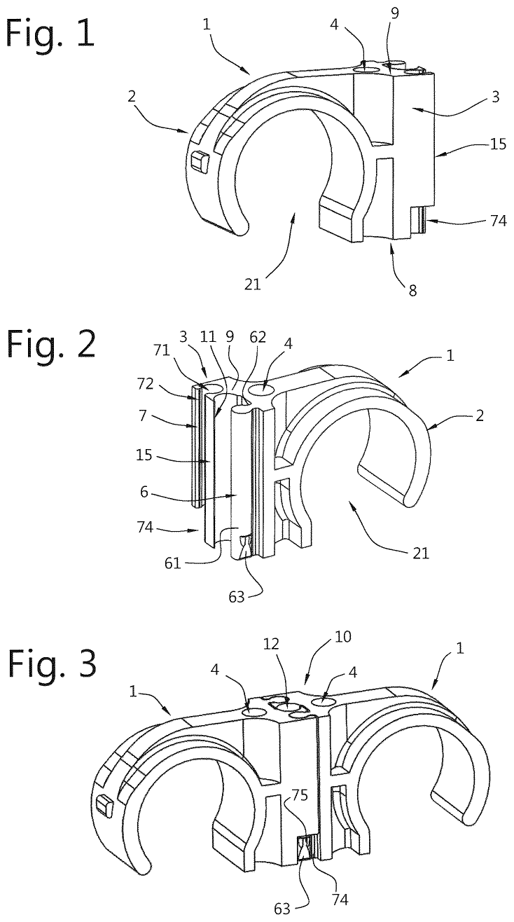

FIGS. 1 and 2 show a pipe clip 1 which comprises a clip portion 2 and a base portion 3 formed in one piece. The pipe clip 1 is made of plastic. The clip portion 2 is adapted to receive and hold a pipe 14 as is shown in FIGS. 12 and 13. The clip portion 2 has an open ring shape with an opening 21 to insert the pipe 14 in the ring shape in substantially a radial direction.

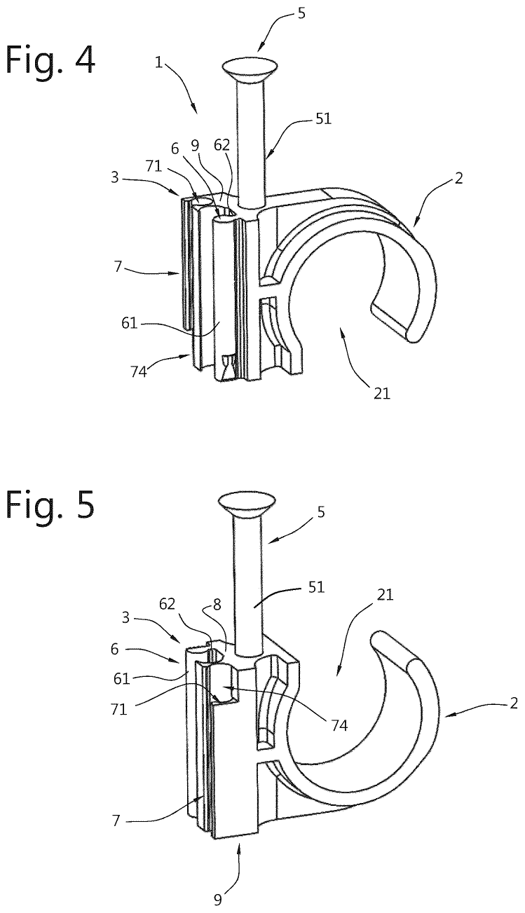

The base portion 3 is adapted to attach the pipe clip 1 to a part of a structure, such as a floor, a wall, a ceiling or another structural part. The base portion 3 is in use positioned with a support surface 8 or 9 against a surface of the structural part. The opposite support surfaces 8 and 9 of the base portion 3 are both adapted to be positioned against a surface of the structural part such as a floor, wall or ceiling, whereby the pipe clip 1 is mountable to said part of the structure in two orientations which is illustrated in FIGS. 4, 5, 12 and 13. The opening 21 is facing the same direction as the support surface 8 of the base portion 3 (cf. FIGS. 4 and 5), such that when the pipe clip 1 rests with the support surface 8 on the support, i.e. the orientation of FIG. 12, the pipe 14 is locked in by the clip portion 2 and the structural part, e.g. the floor, wall or ceiling.

The base portion 3 has a passage 4 for passing through a shaft 51 of a fastener 5, such as a nail, which is shown in FIGS. 4, 5, 12 and 13. Also other fasteners having a shaft, such as a screw are possible. In the shown example the base portion 3 of the pipe clip 1 is attached to the structural part, e.g. a floor, by hammering or shooting the nail through the passage and into the surface of the structural part, e.g. a floor surface.

The base portion 3 has a lateral side 15 which extends from support surface 8 to the opposite support surface 9 of the base portion 3. In the embodiment of FIGS. 1 and 2, the base portion 3 has two coupling members 6, 7 formed on the lateral side 15, and adapted to cooperate with coupling members 6, 7 of another pipe clip 1 for assembling said pipe clips 1 so as to create a dual pipe clip. The assembled state is shown in FIG. 3, wherein two identical pipe clips 1 are assembled to a pipe clip assembly 10, which is a dual pipe clip. One coupling member is a rib 6 and the other coupling member is a channel profile 7. The rib 6 and the channel profile 7 have a longitudinal direction which extends parallel to the passage 4 for the fastener 5. The rib 6 and the channel profile 7 are adapted to cooperate with a channel profile 7 and a rib 6, respectively, of another pipe clip. To that end the respective ribs 6 are inserted in the longitudinal direction in the respective channel profiles 7.

The rib 6 extends in the longitudinal direction from the support surface 8 to the opposite support surface 9 of the base portion 3.

The channel profile 7 comprises a bore 71 having a circular cross section and a longitudinal slot 72 adjoining the bore 71 and forming an opening of the bore 71 along its length. Between the bore and the slot is formed a transition 73 which constitutes an undercut. The rib 6 comprises a thicker rib portion 61 which fits in the bore 71 and a connection portion 72 which fits in the slot 62. The connection portion 72 connects the thicker rib portion 71 to the base portion 3 of the pipe clip 1. The undercut is such that the thicker rib 61 portion cannot exit from the bore 71 in a direction perpendicular to the longitudinal direction.

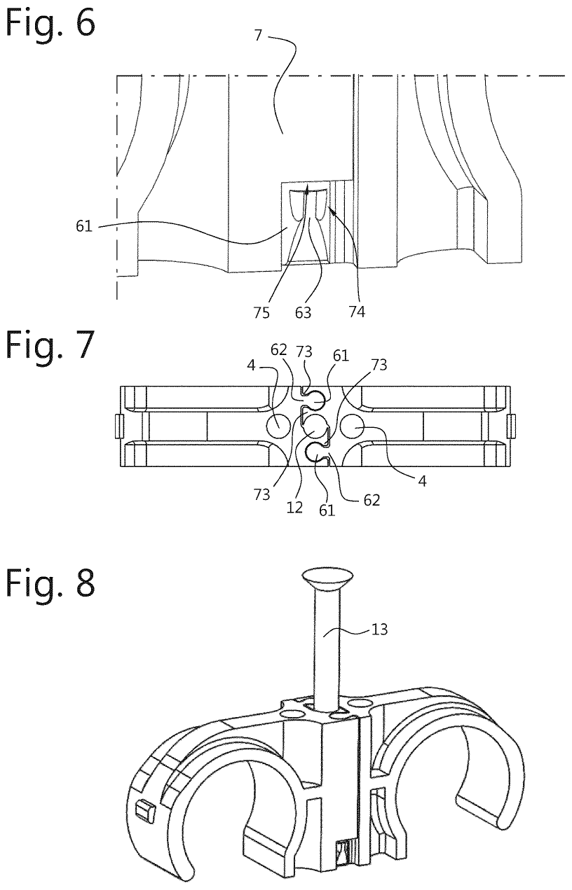

The channel profile 7 has a recess 74 at an end of the bore 71. On the end of the thicker rib portion 61 a snap member 63 is formed. When the thicker rib portion 61 is moved longitudinally through the bore 71 and passes the end of the bore 61, the snap member 63 moves slightly outwards and undercuts the edge 75 of the recess 74, as is visible in FIG. 3 and in more detail in FIG. 6. Thereby the rib 6 is locked in the channel profile 7 and cannot be retracted in the longitudinal direction of the bore 71.

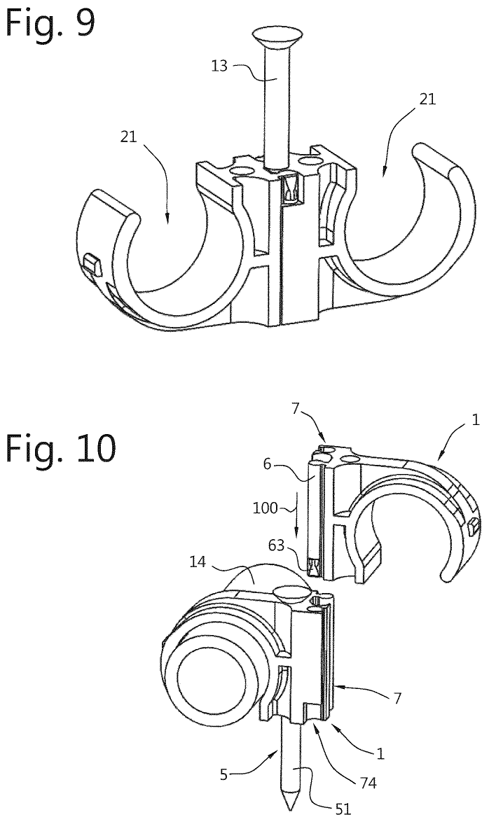

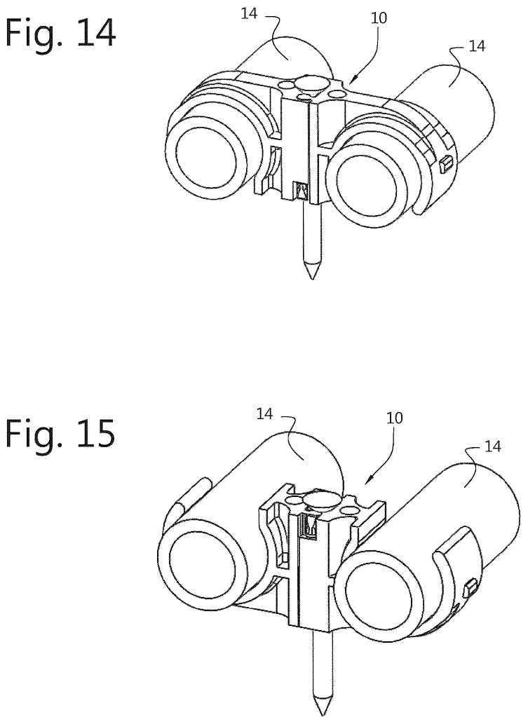

The base portion 3 furthermore includes a passage half 11 formed on a lateral side of the channel profile 7. The passage half 11 is formed such that when the pipe clips 1 are assembled and coupled to each other as described in the above, the respective passage halves 11 are positioned opposite each other and together define an additional passage 12 as is visible in FIGS. 3 and 7. A shaft of a fastener 13 can pass through the additional passage 12, which is illustrated in FIGS. 8 and 9. By the additional passage 12 the assembled dual pipe clip can be mounted with one central fastener 13, in the shown example of FIGS. 8 and 9 a nail. In FIGS. 14 and 15 the pipe clip assembly 10 is shown in different orientations with a pipe received in the respective clip portions 2.

As mentioned in the above the pipe clip 1 can be mounted individually, as shown in FIGS. 4 and 5, or it can be pre-assembled with a similar clip 1 and then be mounted as a dual clip, as shown in FIGS. 8 and 9.

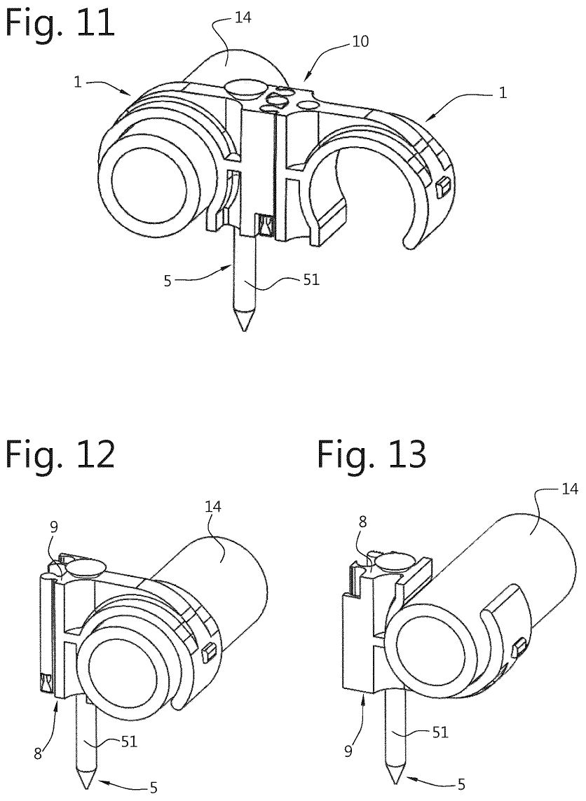

The fastener can be pre-assembled with the individual clip or the assembled dual clip. However, it is also possible to mount an individual pipe clip 1 first and then later retrofit another pipe clip 1 and connect it to the already mounted pipe clip 1. This is illustrated in FIGS. 10 and 11. The pipe clip 1 on the left in FIG. 10 is already mounted to a structural part, such as a floor, and a pipe 14 is already received in the clip portion 2 of the pipe clip 1. When necessary, a second pipe clip 1 (on the right in FIG. 10) can be coupled to the already mounted pipe clip 1, by simply sliding the rib 6 and channel profile 7 of the mounted pipe clip 1 in and over the channel profile 7 and the rib 6, respectively, of the mounted pipe clip 1, as is indicated in FIG. 10 by arrow 100. When the snap members 63 of the ribs 6 move into the recesses 74 in the channel members 7, the pipe clips are firmly coupled and a dual pipe clip is provided which is attached to the floor or other support by the fastener 5 that passes through the passage 4 of the first mounted pipe clip 1 of the pipe clip assembly 10.

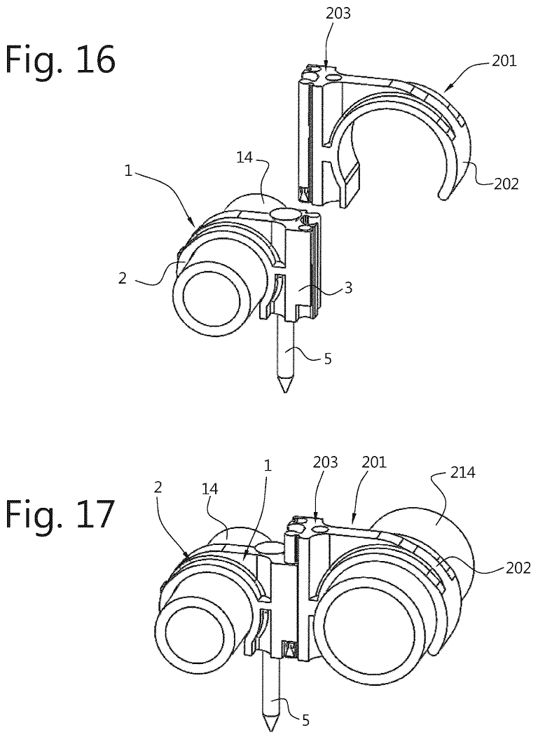

In FIGS. 10 and 11 the pipe clips 1 are identical. However, within the scope of the invention this is not necessary. In FIGS. 16 and 17 is illustrated how two different pipe clips 1 and 201 are coupled. The pipe clip 1 on the left is adapted for receiving a pipe 14 with a certain outer diameter. The pipe clip 201 on the right which is coupled with its base portion 203 to the pipe clip 1 as is described in the above, has a clip portion 202 is adapted to receive a pipe 214 with another diameter, in this example a larger diameter (cf. FIG. 17).

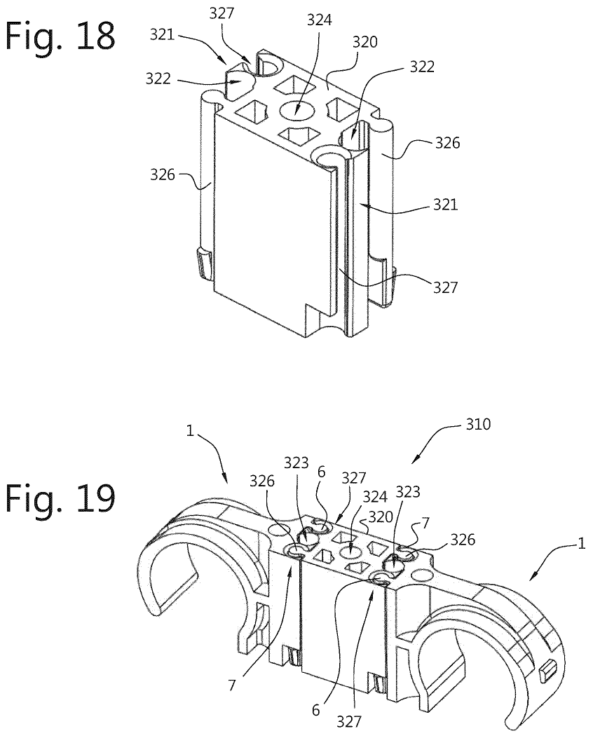

FIG. 19 shows a pipe clip assembly 310 including two pipe clips 1 according to FIG. 1 and further including an auxiliary part 320 adapted to be coupled to the pipe clips 1. In this example the auxiliary part 320 is embodied as a spacer block, preferably made of plastic, for increasing the distance between the central axes of the pipes held by the pipe clips 1. The spacer block 320 is shown separately in FIG. 18 and has lateral sides 321 adapted to be coupled to the lateral sides 15 of the respective base portions 3 of the pipe clips 1 to form the pipe clip assembly 310. At each lateral side 321 of the spacer block 320 a passage half 322 is formed, which is the same as the passage half 11 on the pipe clip 1 such that when said pipe clip 1 and the spacer block 320 are assembled and coupled to each other, the respective passage halves 11 and 322 are positioned opposite each other and together form an additional passage 323 for a shaft of a fastener as is visible in FIG. 19. The spacer block 320 in this case also has a central passage 324 for passing through a shaft of a fastener.

Like the base portion of the pipe clip 1 the spacer block 320 has two coupling members 326, 327 formed on the lateral side 321 of the spacer block 320. The coupling members 326 and 327 are adapted to cooperate with coupling members 6, 7 of the pipe clip 1 for assembling the spacer block 320 and the pipe clip 1. One coupling member is a rib 326 and the other coupling member is a channel profile 327. The rib 326 and the channel profile 327 have a longitudinal direction which extends parallel to the passage 324 for the fastener. The rib 326 and the channel profile 327 are adapted to cooperate with a channel profile 7 and a rib 6, respectively, of a pipe clip 1. To that end the respective ribs 6, 326 are inserted in the longitudinal direction in the respective channel profiles 327, 7 as is shown in FIG. 19.

It is noted that the spacer block 320 is only an example of an auxiliary part. Also other auxiliary parts which have the coupling members as the spacer block are envisaged within the scope of the invention.

1. Pipe A pipe clip comprising a clip portion and a base portion formed in one piece, the clip portion being adapted to receive and hold a pipe and the base portion adapted to attach the pipe clip to a structure,
wherein the base portion has a support surface to be positioned against a part of the structure, e.g. a floor, a wall, a ceiling,
wherein the base portion has a passage extending through the base portion from the support surface to an opposite surface of the base portion for a shaft of a fastener to attach the base portion of the respective pipe clip to the structure,
wherein the base portion is adapted to be coupled to a base portion of another pipe clip so as to form a pipe clip assembly
wherein
the base portion has a lateral side which extends from said support surface of the base portion to said opposite surface of the base portion which lateral side is adapted to be coupled to a lateral side of the base portion of said other pipe clip to form the said pipe clip assembly wherein the clip portions of the pipe clip assembly are located lateral from each other,
and in that the base portion includes a passage half at said lateral side formed such that when said pipe clips are assembled and coupled to each other, the respective passage halves are positioned opposite each other and together form an additional passage for a shaft of a fastener

2. The pipe clip according to claim 1, wherein the pipe clip is made of plastic.

3. The pipe clip according to claim 1, wherein the base portion has at said lateral side at least one coupling member adapted to cooperate with a coupling member of the other pipe clip for assembling said pipe clips so as to create a dual pipe clip.

4. The pipe clip according to claim 3, wherein said at least one coupling member comprises a rib or a channel profile, adapted to cooperate with a channel profile and rib respectively, of said other pipe clip.

5. The pipe clip according to claim 4, wherein the rib or channel has a longitudinal direction which extends substantially from the support surface to the opposite surface of the base portion.

6. The pipe clip according to claim 5, wherein the rib or channel extends parallel to the passage for the fastener

7. The pipe clip according to claim 4, wherein said channel profile comprises a bore having a circular cross section and a longitudinal slot adjoining the bore and forming an opening of the bore along its length, wherein the transition of the slot to the bore constitutes an undercut, and
said rib being adapted to be inserted in the longitudinal direction in the channel profile, wherein the rib comprises a thicker rib portion which fits in the bore and a connection portion which fits in the slot and which connects the thicker rib portion to the base portion of the pipe clip,
wherein the undercut is such that the thicker rib portion cannot exit from the bore in a direction perpendicular to the longitudinal direction.

8. The pipe clip according to claim 1, wherein said opposite surface of the base portion is also a support surface adapted to be positioned against said part of a structure such as a floor, wall or ceiling, whereby the pipe clip is mountable to said part of the structure in two orientations.

9. The pipe clip according to claim 1, wherein the clip body has an open ring shape with an opening to insert the pipe in the ring shape in substantially a radial direction, wherein the opening is facing the same direction as the support surface or said opposite surface of the base portion

10. A pipe clip assembly comprising a first pipe clip and a second pipe clip each according to claim 1.

11. The pipe clip assembly according to claim 10, wherein, in the assembled state, each of the first and the second pipe clip are coupled to each other and the respective passage halves are positioned opposite each other and together form an additional passage for a shaft of a fastener

12. The pipe clip assembly according to claim 10, wherein the channel profile has a recess at an end of the the bore and wherein a snap member is formed on the end of the thicker rib portion, such that when the rib is moved through the bore and passes the end of the bore the snap member undercuts the edge of the recess whereby the rib cannot be retracted in the bore.

13. The pipe clip assembly according to claim 10, wherein the first pipe clip and the second pipe clip are identical.

14. The pipe clip assembly according to claim 10, wherein the first pipe clip and the second pipe clip are similar, and wherein the clip portion of the first pipe clip is suitable for receiving another pipe diameter than the clip portion of the second pipe clip.

15. A pipe clip assembly comprising at least one pipe clip according to claim 1, and further comprising an auxiliary part adapted to be coupled to the pipe clip wherein the auxiliary part has a lateral side adapted to be coupled to a lateral side of the base portion of the pipe clip to form the said pipe clip assembly wherein the auxiliary part includes a passage half at said lateral side thereof, formed such that when said pipe clip and said auxiliary part are assembled and coupled to each other, the respective passage halves are positioned opposite each other and together form an additional passage for a shaft of a fastener.
